(19) United States
(12) Patent Application Publication
(10) Pub. No.: US 2020/0178500 A1
(43) Pub. Date: Jun. 11, 2020

(54) Animal Feeder with Selective Access Controlled by Image Recognition

(71) Applicant: Shane D. Winn, Woodward, OK (US)

(72) Inventor: Shane D. Winn, Woodward, OK (US)

(21) Appl. No.: 16/212,024

(22) Filed: Dec. 6, 2018

(51) Int. Cl. A01K 5/01; A01K 5/02; A01M 31/00

(52) U.S. Cl. CPC A01K 5/0142; A01M 31/008; A01K 5/02

(57) ABSTRACT

A controller for an animal feeder uses image recognition to classify a species, and optionally an age and gender, of an animal at a dispenser for the feeder. Based upon the image recognition, the controller enables access or denies access to feed based upon permitted and non-permitted species, gender and age.

### BACKGROUND

Animal feeders on farms, ranches, in zoos, and in the wilderness are susceptible to food theft by undesired animals for which the feed is not intended. For example, a deer feeder is often set up and loaded with feed such as pellets or corn, and then left in a hunting area for the indigenous deer to find. However, other large animals such as cattle, and varmints such as racoons and squirrels, may also steal the feed because the feeder device has no way of dispensing the feed only to the intended animal (deer).

### SUMMARY OF THE DISCLOSED EMBODIMENT(S) OF THE INVENTION

A controller for an animal feeder is disclosed which uses image recognition to classify a species, and optionally an age and gender, of an animal at a dispenser for the feeder. Based upon the recognition, the controller enables access or denies access to feed based upon permitted and non-permitted species, and optionally gender and age.

### BRIEF DESCRIPTION OF THE DRAWINGS

The figures presented herein, when considered in light of this description, form a complete disclosure of one or more embodiments of the invention, wherein like reference numbers in the figures represent similar or same elements or steps.

FIG. 1 illustrates in a perspective view an exemplary embodiment of the present invention atop a feeder chute with the feeder chute gate in an open (unrestricted) position.

FIG. 2 illustrates in a perspective view an exemplary embodiment of the present invention atop a feeder chute with the feeder chute gate in an closed (restricted) position.

FIG. 3 illustrates in a top-down view an exemplary embodiment according to at least one embodiment of the present invention.

FIG. 4 provides a contextual depiction of a feeder chute according to the present invention configured to a feeder reservoir and stand for access by an animal such as a deer.

FIG. 5 provides a system diagram of components according to at least one embodiment of the present invention.

FIG. 6 sets forth a logical process for controlling access to a feeder chute according to at least one embodiment of the present invention.

### DETAILED DESCRIPTION OF EMBODIMENT(S) OF THE INVENTION

### Problem(s) Recognized

The present inventor has recognized a problem with various feeder chutes in the available art which have not been recognized by others so far. Consider, for example, deer feeders which are loaded and left in woods, forests, pastures, etc., to attract and feed deer. Many of them have chutes which provide a fixed opening size that is smaller than the muzzle width of local cattle in an attempt to keep the cattle from stealing and consuming the feed. However, for some reason, the cattle continue to access the feed, as do other varmints. For the purposes of this disclosure, we will refer to two different kinds of animals, cattle and deer, and those skilled in the art will readily recognize that other kinds of animals having certain physiological differences in their snout or muzzle structures and their tongues may be equally well served by embodiments of the present invention.

The present inventor has discovered that this is because present-day feeder chutes only reject animals based on a fixed or static muzzle width, but there is also a physiological difference between deer and cattle in how their tongues move and extend. For example, a deer's tongue does not extend as far as a cow's tongue, and it does not roll up like a cow's. So, a deer must take feed from a chute which has a horizontal floor in it by rotating its head slightly.

Thus, in order for a deer to readily feed from a chute, the opening must be somewhat wider than the actual width of the deer's muzzle. This opening, however, can be smaller than the width of a cow's muzzle in the chutes of the present art, but the cow can still steal feed by extending and/or rolling its tongue up and into the chute. Then, the cow essentially licks the feed from the chute, thereby defeating the structure's attempt to selectively dispense feed only to the deer.

Having discovered this second (additional) physiological difference between deer and cattle, the present inventor set about designing and experimenting with various chute designs which would be more effective in dispensing feed only to the smaller muzzle animal, such as a deer, and effectively blocking access to a larger muzzle animal, such as a cow. The resulting invention patented by the present inventor in U.S. Pat. No. 10,064,386 (hereinafter '386 patent). This passively-controlled feeder chute provided a solution for feeders in which the chute is upgraded or replaced according to the patent. However, the present inventor has further realized that such a solution is not always applicable to user who may already own a feeder system, especially a system for which the feeder chute is not easily replaced or changed.

So, the present inventor has devised the following invention which can be used in conjunction with the afore-mentioned feeder chute, as well as easily adapted to and configured onto existing feeder chutes that do not incorporate the inventive features of the '386 patent. In particular, the present invention provides a image-recognition based active control of a feeder chute gate to allow only certain species, and optionally, only certain ages and/or genders, to access the feed. Embodiments may include after-market add-on devices, as well as built-in or integrated (OEM) devices. For the purposes of illustration, the present invention will be described in conjunction with use with a feeder chute according to the '386 patent, but those ordinarily skilled in the art will realize that the present invention may be used separately from the chute of the '386 patent, as well.

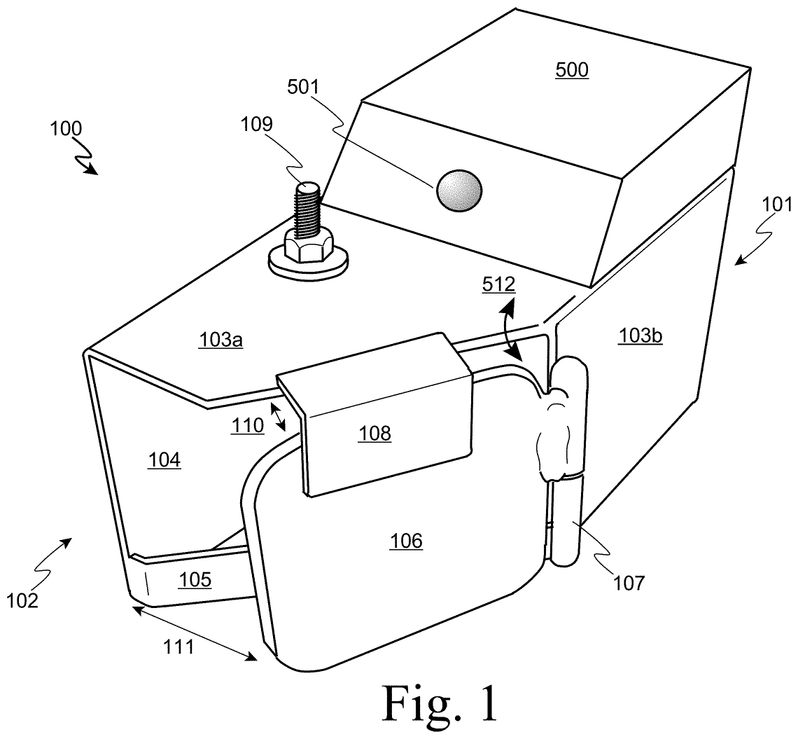

Referring now to FIG. 1, an exemplary feeder chute (100) embodiment according to the '386 patent is shown, improved by the addition of an embodiment of the present invention (500) mounted, in this example, atop the chute (100). Other embodiments may mount the invention (500) inside, to the side, below, or in other positions relative to the chute with equal utility. The chute (100) has a receiver end (101) for receiving feed (pellets, corn, seeds, etc.) from a reservoir, and a dispenser end (102) for taking of the feed by an animal, this particular example being formed generally from stock metal tubing, such as 4″ square tubing. Other embodiments may use other shapes, or may be formed from one or more pieces of flat stock material. In this view, a top (103a) and right side (103b) of the chute are visible, and an interior surface of a left side (104) is also visible. A bottom is not visible in this perspective, but it is obviously present. The tested prototype was about 3.5″ long on the left side (104) and about 6.5″ long on the right side (103b). Throughout this disclosure, we will refer to right side and left side for the exemplary embodiments, but those skilled in the art will realize that the sides may be reversed without departing from the spirit and scope of the present invention.

Formed along a diagonal edge of the bottom of the dispenser end is a lip (105) which allows the feed to enter from a reservoir into the receiver end (101) and slide on the bottom until it reaches the lip (105) which acts as a detente, holding the feed there until taken by an animal of the desired kind. The tested prototype lip was about 0.5″ tall.

The chute (100) is also provided with a gate (106) which is hinged to the side (103b) and forced to an open position by a return spring attached (109) to the top (103a) of the chute, with the gate (106) swinging open until it reaches a fully-open detente (108) as shown. The gate in the tested prototype was about 4″-5″ long. Other forms of detente may be used in place of the angle-iron example in this embodiment. A spring-loaded hinge may be used in place of the separate return spring, however, some spring loaded hinges may include a certain amount of lubricant or grease which may warn off a deer. When the gate is in the full open position, a full open width (111) between the left side (104) and the dispenser-end edge of the gate (106) which is sufficient to receive a deer's nose and provide extra room for head rotation to allow the deer's tongue to retrieve the feed at the lip (105). However, this fully open space (111) is preferably less than the width of the nose of the cattle to be rejected by the chute. In some embodiments, the fully open detente gap (110) may be adjustable to accommodate the muzzles and tongues of the cattle to be rejected and allow access by various sizes of deer to be fed.

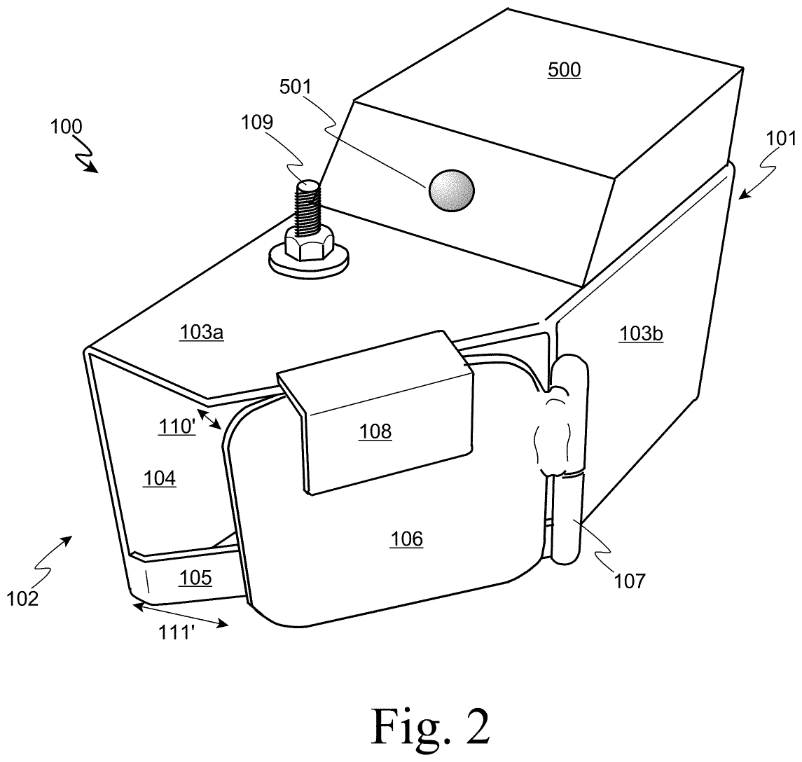

To prevent the non-permitted species, such as a cow, from simply articulating its tongue into the chute to retrieve feed, the gate swings to a closed position as shown in FIG. 2 upon urging by the nose of the cow on the dispenser edge of the gate (106). In this fully closed position, the fully-closed space (111′) between the dispenser-end edge of the gate (106) and the left side (104) of the chute is sufficiently small to prevent entry of a cows tongue, even when rolled, such as approximately 2″ wide by 4″ tall in the tested prototype. The gate, in this embodiment, swings to the closed position when it reaches, for example, the lip (105) or the diagonal edge of the top (103a), or both. Other fully-closed position detents may be possible, including adjustable fully-closed detents to allow the closed gap (110′) to accommodate various sizes of deer to be fed and various sizes of cattle to be rejected. The exemplary embodiment of the present invention (500) provides an active control to close (512) the gate (106) according to an image recognizer with, for example, a local camera (501), which has a field of view (FOV) including an animal present at the dispensing end (102) of the chute. In other embodiments wherein the gate is not forced open passively by a spring, the present invention (500) may also actively force the gate to an open position to allow a permitted species to access the feed.

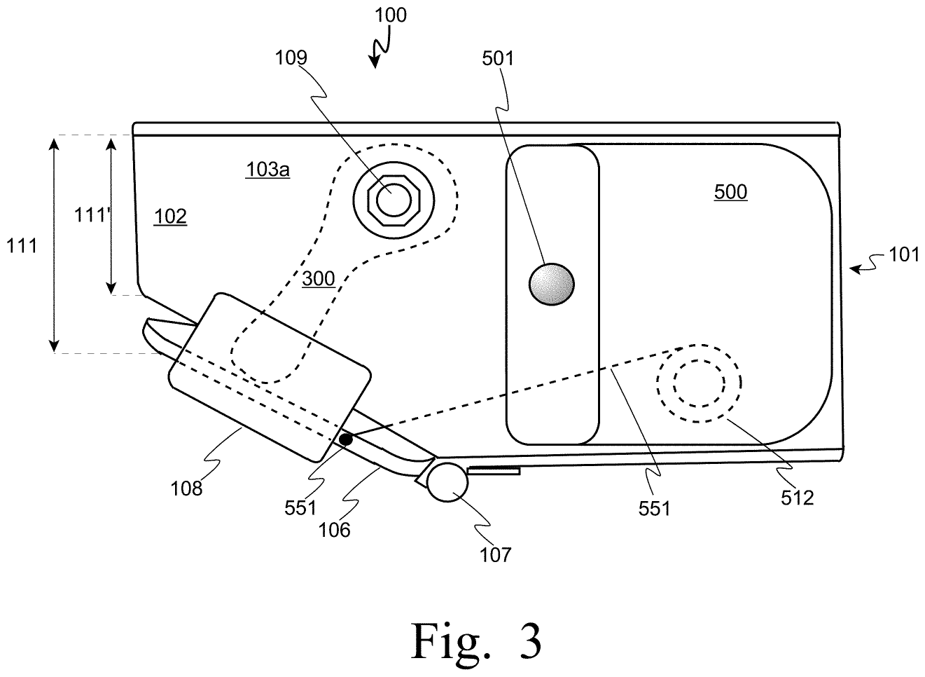

Turning now to FIG. 3, a top-down view of the exemplary embodiment of a chute (100) according to the '386 patent is shown. In this configuration, the fully-open width (111) is about 2.25″, and the fully-closed width (111′) is about 1″. The present invention (500) is shown with at least one available mechanism to pull the gate to a closed position, including a motor-actuated pulley (512) which tugs on a cable (551) which is connected (551) to the gate (106). Other embodiments may utilize an arm, rod, electromagnet(s), gear(s), or other form of electrically-controllable closer to close the gate. The exemplary embodiment shown can be provided in a configuration which supports after-market attachment to a feeder chute, such as providing a clip-on attachment point (551).

According to usage experiments, an end section of a rubber tie-down strap (300) is retained by bolt (109) in the interior of the chute, position such that it naturally pushes against the interior surface of the gate (106) to press it towards the fully-open position as defined by the detente (108). Experiments have shown that this material and fastening means do not ward off deer, but other suitable spring means may be used as appropriate.

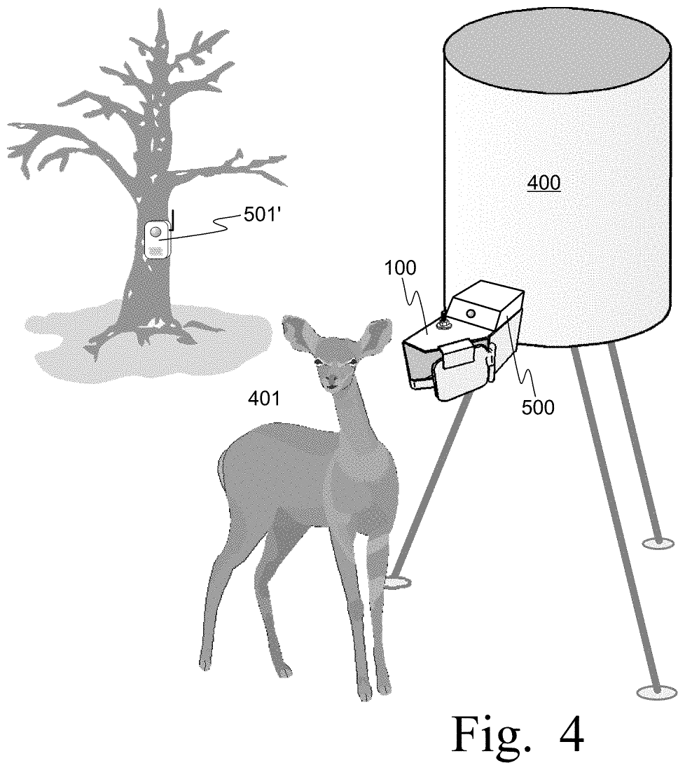

FIG. 4 shows the example embodiment using a '386 patent chute (100) in the context of being configured with the receiver end communicating with the output of a feeder reservoir (400) such as an deer feeder having an auger or gravity-fed barrel, and with the dispensing end positioned in a manner suitable for taking of feed by a desired animal (401). In this configuration, the one or more cameras of the present invention (500) have a FOV including the area nearby the dispensing end of the chute in order to detect the arrival of an animal, and to further classify it as a permitted or non-permitted feeder. For example, the chute mounted unit (500) may have an integral camera, or it may communicate with a remotely-mounted camera (501′), or both, to perform this detection and classification. The chute may be configured with a horizontal bottom essentially level such that the feed is advanced from the receiving end towards the dispensing end by pressure of feed from the reservoir (e.g., auger turns, etc.), or it may be configured with the bottom slightly angled downward towards the dispensing end to provide for gravity-driven advancement of the feed towards the dispensing end. More than one chute can be configured to each feeding reservoir, and the reservoirs may be other shapes than cylindrical, such as rectangular, square, etc.

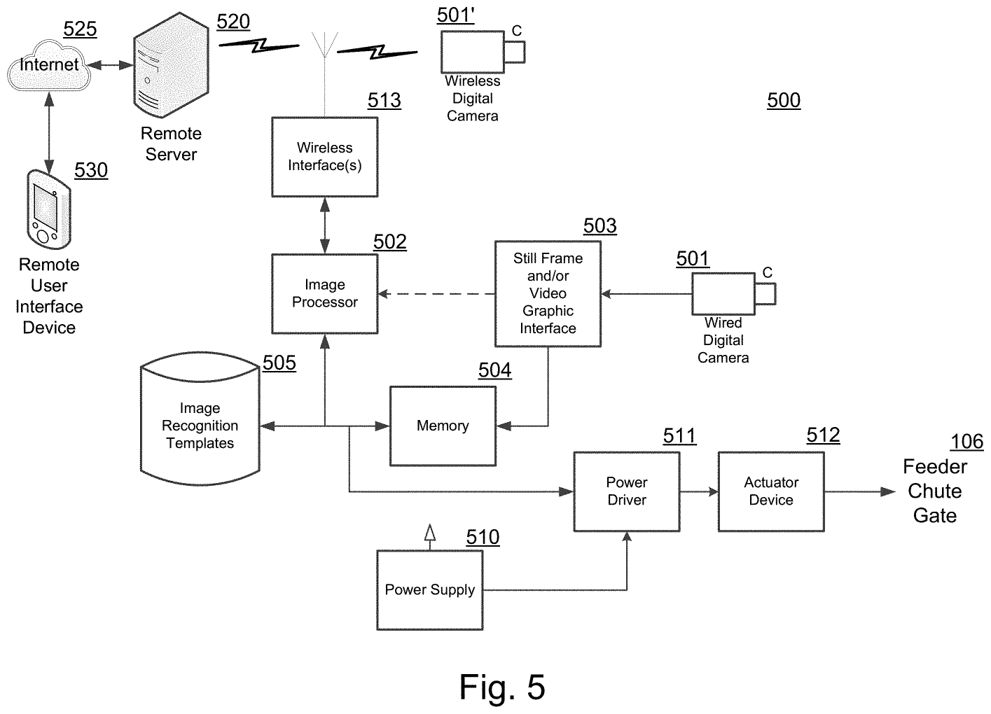

Turning now to FIG. 5, a system diagram of components of at least one embodiment of an image-recognition based active controller (500) for a feeder chute is shown. It potentially includes a local camera (501), and potentially a remote camera (501′) with a wireless interface (513). An image processor (502), such as a specially-programmed microcontroller or embedded microprocessor, may receive digital still images, digital videos, or both, via a graphical interface device (503) or the wireless interface(s) (513). The digital images may be transferred directly to memory (504), such as by direct memory access (DMA), in some embodiments. The image processor (502) may detect the arrival of an unclassified animal in the digital image(s), and the proceed to perform image recognition, optionally using one or more templates (505), including, but not limited to, determining a species, an age, and/or a gender of the animal present at the dispensing end of the feeder chute.

Upon determining that the animal is a non-permitted species, age or gender, the system (500) activates a power driver (511) to control the actuator device (512) (e.g., pulley, electromagnet, etc.) to close the feeder chute gate, in embodiments where the gate is normally (passively) open. In other embodiments in which the gate is not normally open, the system (500) may also activate the power driver (511) to control the actuator device (512) to open the feeder chute gate responsive to determination that the animal is a permitted species, age, and/or gender.

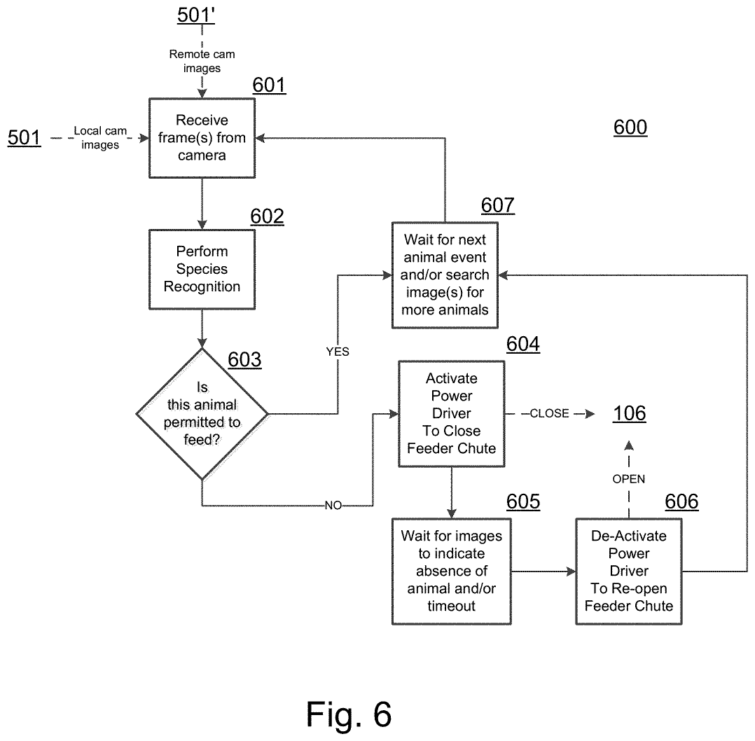

Referring now to FIG. 6, an exemplary logical process (600) for controlling the gate according to the present invention is shown. Video frame(s) or images are received (601) from the camera(s), and species recognition (602) is performed. If the species determination (603) is a permitted species, then the gate is left open (for embodiments with normally open gates) to allow the animal to feed. If the species determination (603) is of a non-permitted species, then the power driver is activated (604) to close the feeder chute to prevent feeding. In other embodiments, the species determination may also determine one or more of approximate age, size, weight, and/or gender of the animal, and may permit or deny feeding according to age, size, weight limits, as well.

The system can then wait (605) a specified time before re-opening (606) the gate, or continue to monitor the images until it is determined the animal is no longer present (605) to re-open (606) the gate, or a combination of both. Eventually, the system returns to waiting (607) for the next animal to arrive, to repeat the image recognition, permission determination, and gate controlling.

Other embodiments of this logical process (600) include variations in which the gate is normally closed, so the controller actively opens the gate for permitted species, as well as variations in which the controlled actively opens and actively closes the gate without regard to a default state of the gate.

In another embodiment of the present invention, the image recognition-based controller is adapted to turn on and turn off an auger in the feeder which, when on, delivers a flow of feed to the feeder chute, with or without a gate mechanism.

### CONCLUSION

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof, unless specifically stated otherwise.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

It will be readily recognized by those skilled in the art that the foregoing example embodiments do not define the extent or scope of the present invention, but instead are provided as illustrations of how to make and use at least one embodiment of the invention. The following claims define the extent and scope of at least one invention disclosed herein.

What is claimed is:

1. A system for controlling dispensing of animal feed comprising:
one or more imaging devices which captures a field of view of a dispensing end of a feeder chute;
an image recognizer which, responsive to an animal appearing in the field of view, determines at least a species of the animal from digital images captured by the one or more imagining devices;
a controller which, responsive the determining of at least the species, operates a regulator of the feeder chute to enable access of feed by a permitted species and deny access of feed by a non-permitted species.

2. The controller as set forth in claim 1 wherein the regulator comprises a gate disposed at the dispensing end of the feeder chute.

3. The controller as set forth in claim 1 wherein the regulator comprises an auger disposed to deliver feed to the dispensing end of the feeder chute.

4. The controller as set forth in claim 1 wherein the one or more imaging devices comprise a digital still camera.

5. The controller as set forth in claim 1 wherein the one or more imaging devices comprise a digital video camera.

6. The controller as set forth in claim 1 wherein the one or more imaging devices comprise a remotely networked camera.

7. The controller as set forth in claim 1 wherein the image recognizer is further configured to determine an age of the animal, and wherein the controller is further configured to enable and deny access of feed according to permitted ages and non-permitted ages of the animal.

8. The controller as set forth in claim 1 wherein the image recognizer is further configured to determine a gender of the animal, and wherein the controller is further configured to enable and deny access of feed according to permitted ages and non-permitted genders of the animal.

9. The controller as set forth in claim 1 wherein the image recognizer is further configured to determine a size of the animal, and wherein the controller is further configured to enable and deny access of feed according to permitted sizes and non-permitted sizes of the animal.

10. The controller as set forth in claim 1 wherein the image recognizer is further configured to determine a weight of the animal, and wherein the controller is further configured to enable and deny access of feed according to permitted weights and non-permitted weights of the animal.

11. A method for controlling dispensing of animal feed comprising steps of:
receiving, by an electronic controller, from one or more imaging devices, one or more captured digital images of a field of view of a dispensing end of a feeder chute;
responsive to an animal appearing in the field of view, determining, by an electronic image recognizer, at least a species of the animal from the received one or more digital images;
responsive the determining of at least the species, operating, by the electronic controller, a physical regulator of the feeder chute to enable access of feed by a permitted species, and denying, by the electronic controller, access of feed by a non-permitted species.

12. The method as set forth in claim 11 wherein the regulator comprises a gate disposed at the dispensing end of the feeder chute.

13. The method as set forth in claim 11 wherein the regulator comprises an auger disposed to deliver feed to the dispensing end of the feeder chute.

14. The method as set forth in claim 11 wherein the one or more imaging devices comprise a digital still camera.

15. The method as set forth in claim 11 wherein the one or more imaging devices comprise a digital video camera.

16. The method as set forth in claim 11 wherein the one or more imaging devices comprise a remotely networked camera.

17. The method as set forth in claim 11 further comprising determining, by the electronic image recognizer, an age of the animal, and further comprising enabling and denying feed access, by the electronic controller, according to permitted ages and non-permitted ages of the animal.

18. The method as set forth in claim 11 further comprising determining, by the electronic image recognizer, a gender of the animal, and further comprising enabling and denying access of feed, by the electronic controller, according to permitted ages and non-permitted genders of the animal.

19. The method as set forth in claim 11 further comprising determining, by the electronic image recognizer, a size of the animal, and further comprising enabling and denying feed access, by the electronic controller, according to permitted sizes and non-permitted sizes of the animal.

20. The method as set forth in claim 11 further comprising determining, by the electronic image recognizer, a gender of the animal, and further comprising enabling and denying access of feed, by the electronic controller, according to permitted gender and non-permitted gender of the animal.
